(19) United States
(12) Patent Application Publication
(10) Pub. No.: US 2013/0333920 A1
(43) Pub. Date: Dec. 19, 2013

(54) METALLIC GLASS, ARTICLE, AND CONDUCTIVE PASTE

(71) Applicants: Industry-Academic Cooperation Foundation, Yonsei University, (US); SAMSUNG ELECTRONICS CO., LTD., Suwon-Si (KR)

(72) Inventors: Se-Yun KIM, Seoul (KR); Eun-Sung LEE, Hwaseong-si (KR); Suk-Jun KIM, Suwon-si (KR); Jin-Man PARK, Seoul (KR); Sang-Soo JEE, Hwaseong-si (KR); Do-Hyang KIM, Seoul (KR); Ka-Ram LIM, Seoul (KR)

(73) Assignees: Industry-Academic Cooperation Foundation, Yonsei University, Seoul (KR); SAMSUNG ELECTRONICS CO., LTD., Suwon-Si (KR)

(21) Appl. No.: 13/759,475

(22) Filed: Feb. 5, 2013

(30) Foreign Application Priority Data
Jun. 13, 2012 (KR) 10-2012-0063081

(51) Int. Cl. C22C 45/00; H01B 1/02

(52) U.S. Cl. CPC C22C 45/00; H01B 1/02
USPC 174/126.1; 428/469; 148/403; 252/512; 252/514; 252/513

(57) ABSTRACT

Disclosed are a metallic glass including an amorphous alloy part including a plurality of elements; and an amorphous oxide in a supercooled liquid region, an article including a sintered product of the metallic glass, and a conductive paste including the metallic glass.

### CROSS-REFERENCE TO RELATED APPLICATION

This application claims priority under 35 U.S.C. §119 to Korean Patent Application No. 10-2012-0063081 filed in the Korean Intellectual Property Office on Jun. 13, 2012, the entire contents of which are incorporated herein by reference.

### BACKGROUND

1. Field

Example embodiments relate to a metallic glass, an article including a sintered product of a metallic glass, and/or a conductive paste including a metallic glass.

2. Description of the Related Art

A metallic glass may be an alloy having a disordered atomic structure including two or more metals. The metallic glass may have a supercooled liquid region (which is a temperature region between a glass transition temperature (Tg) and a crystalline temperature (Tx)), and a decreased viscosity to exhibit liquid-like behavior within the supercooled liquid region.

When the metallic glass is sintered in the supercooled liquid region, it may be easier to deform than a conventional metal, which may make processing easier. Also, the metallic glass wets better on a lower layer within the supercooled liquid region, which enhances the adhesion between the metallic glass and the lower layer

In order to improve the processability and the wettability of metallic glass, it is beneficial to extend the supercooled liquid region. However, when one or more elements are added to the metallic glass to extend the supercooled liquid region, the oxide structure formed on the surface of the metallic glass is transformed, so oxygen ions easily permeate and oxidation may occur more rapidly.

### SUMMARY

Example embodiments relate to a metallic glass with improved oxidation resistance as well as to an extended supercooled liquid region.

Example embodiments relate to an article including a product of the metallic glass.

Example embodiments relate to a conductive paste including the metallic glass.

According to example embodiments, a metallic glass includes an amorphous alloy part including a plurality of elements, and an amorphous oxide in a supercooled liquid region.

In example embodiments, the amorphous oxide may be on a surface of the amorphous alloy part.

In example embodiments, the metallic glass may include at least three elements having a Gibbs free energy of oxide formation per mole of oxygen (O₂) of about −900 kJ/mol to about −1250 kJ/mol.

In example embodiments, the at least three elements in the metallic glass may be selected from aluminum (Al), titanium (Ti), zirconium (Zr), beryllium (Be), magnesium (Mg), barium (Ba), manganese (Mn), lithium (Li), yttrium (Y), calcium (Ca), uranium (U), europium (Eu), strontium (Sr), lanthanum (La), cerium (Ce), neodymium (Nd), ytterbium (Yb), samarium (Sm), thorium (Th), dysprosium (Dy), lutetium (Lu), holmium (Ho), thulium (Tm), erbium (Er), and scandium (Sc).

In example embodiments, the at least three elements in the metallic glass may include zirconium (Zr), aluminum (Al), and beryllium (Be).

In example embodiments, the metallic glass may further include a low resistance element having resistivity of less than about 15 μΩcm. The at least three kinds of elements in the metallic glass may be different than the low resistance element.

In example embodiments, the low resistance element may include at least one of copper (Cu), aluminum (Al), silver (Ag), and gold (Au).

In example embodiments, the metallic glass may include copper (Cu), zirconium (Zr), aluminum (Al), and beryllium (Be).

In example embodiments, the amorphous oxide may include amorphous zirconium oxide (ZrO₂).

According to example embodiments, an article includes a sintered product of the metallic glass including an amorphous alloy part including a plurality of elements and amorphous oxide.

According to example embodiments, a conductive paste including a conductive powder, the metallic glass including an amorphous alloy part including a plurality of elements and the amorphous oxide, and an organic vehicle is provided.

The conductive powder may include one of aluminum (Al), silver (Ag), copper (Cu), nickel (Ni), alloys thereof, and a combination thereof.

The conductive powder, the metallic glass, and the organic vehicle may be included in amounts of about 30 wt % to about 99 wt %, about 0.1 wt % to about 20 wt %, and a balance amount, respectively, based on the total amount of the conductive paste.

According to example embodiments, an electronic device including an electrode including a sintered product of the conductive paste is provided.

### BRIEF DESCRIPTION OF THE DRAWINGS

The foregoing and other features and advantages of example embodiments will be apparent from the more particular description of non-limiting embodiments, as illustrated in the accompanying drawings in which like reference characters refer to the same parts throughout the different views. The drawings are not necessarily to scale, emphasis instead being placed upon illustrating principles of example embodiments. In the drawings:

FIG. 1A is a transmission electron microscope (TEM) photograph showing the oxide layer of metallic glass specimen according to Preparation Example 1,

FIG. 1B is a transmission electron microscope (TEM) photograph showing an enlarged portion of the oxide layer shown in FIG. 1A,

FIG. 2A is a transmission electron microscope (TEM) photograph showing the oxide layer of a metallic glass specimen according to Comparative Preparation Example 1,

FIG. 2B is a transmission electron microscope (TEM) photograph showing an enlarged portion of the oxide layer shown in FIG. 2A,

FIG. 3A is a transmission electron microscope (TEM) photograph showing the oxide layer of the metallic glass specimen according to Comparative Preparation Example 2,

FIG. 3B is a transmission electron microscope (TEM) photograph showing an enlarged portion of the oxide layer shown in FIG. 3A, and

FIG. 4 is a graph showing a weight change depending upon the temperature of metallic glass specimens according to Preparation Example 1 and Comparative Preparation Examples 1 to 4.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, the thicknesses of layers and regions are exaggerated for clarity. Like reference numerals in the drawings denote like elements, and thus their description may be omitted.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, the term “element” may refer to a metal and a semimetal.

Hereinafter, a metallic glass according to example embodiments is disclosed.

The metallic glass may be an alloy having a disordered atomic structure including two or more elements, and may be referred to as an amorphous metal. The metallic glass includes an amorphous part that is formed by a rapid solidification of a plurality of elements. The amorphous part may be about 50 to 100 wt % of the metallic glass, specifically about 70 to 100 wt %, and more specifically about 90 to 100 wt %.

The metallic glass may maintain an amorphous part formed when having been a liquid phase at a high temperature even at room temperature. Accordingly, the metallic glass is different from a general alloy having a regular crystalline structure of elements, and also from a liquid metal having a liquid phase at room temperature.

The metallic glass according to example embodiments includes an amorphous alloy part including an amorphous phase of a plurality of elements and an amorphous oxide on the surface of the amorphous alloy part. In other words, the metallic glass according to example embodiments may be part of a composition that includes the metallic glass and the amorphous oxide on the surface of the amorphous alloy part of the metallic glass.

The metallic glass may include a low resistance element having low resistivity.

The low resistance element is a component determining conductivity of metallic glass, and may have resistivity of lower than about 15 μΩcm. Such an element may include at least one selected from, for example, copper (Cu), aluminum (Al), silver (Ag), and gold (Au), but is not limited thereto.

The metallic glass may include an element capable of extending a supercooled liquid region (ΔTx) of metallic glass. The supercooled liquid region (ΔTx) is a temperature region between the glass transition temperature (Tg) and the crystalline temperature (Tx), and the metallic glass may be softened in the supercooled liquid region (ΔTx) and exhibit a liquid-like behavior.

The element for extending the supercooled liquid region (ΔTx) is a component that may lower the glass transition temperature (Tg) of metallic glass by reducing (and/or preventing) the interaction of other elements so as to exhibit liquid behavior at a lower temperature and/or a component that may increase the crystalline temperature (Tx) by reducing (and/or preventing) the interaction of other elements to suppress the nuclear formation of other elements and to delay the crystallization.

When the metallic glass is applied on a lower layer such as a substrate as a powder type, the metallic glass is softened during the supercooled liquid region (ΔTx) by a heating process and exhibits liquid-like behavior and shows wettability to the lower layer. In addition, when the metallic glass is applied for manufacturing an article, the metallic glass softened within the supercooled liquid region (ΔTx) is input into a mold having a predetermined or desired shape to perform thermoplastic forming. When the supercooled liquid region (ΔTx) is extended, the wettability and thermoplastic processability may be enhanced.

The elements for extending the supercooled liquid region may include, for example, aluminum (Al), titanium (Ti), or the like, but are not limited thereto.

The metallic glass may include a group of oxidation resistance elements having a higher oxidative property than the low resistance elements.

The group of oxidation resistance elements includes elements having a higher oxidative property than the low resistance elements. The elements having a higher oxidative property are previously oxidized to the low resistance elements in air, so as to provide a stable oxide layer on the surface of metallic glass, thereby, oxidization of the low resistance element is reduced or prevented.

The group of oxidation resistance elements may include elements having a similar oxidative property. The group of oxidation resistance elements may include at least three kinds of elements. The elements having a similar oxidative property may be substantially simultaneously involved in forming an oxide to reduce (and/or prevent) formation of a crystalline oxide and to provide an amorphous oxide.

The crystalline oxide such as a monoclinic oxide and a tetragonal oxide has a plurality of oxygen vacancies in the crystalline structure, so the oxidation may be quickly performed by diffusing oxygen ions through the oxygen vacancies in the supercooled liquid region. On the other hand, since the amorphous oxide has few oxygen vacancies, the quick oxidation may be reduced (and/or prevented) when diffusing oxygen ions in the supercooled liquid region, so the oxidation resistance may be improved.

The elements having the similar oxidative property may be selected from elements having a Gibbs free energy of metal oxide formation (Δ_{f}G) within the predetermined or desired range. Gibbs free energy of metal oxide formation (Δ_{f}G) refers to a degree of how easily something is oxidized in the air, and the elements having Gibbs free energy of metal oxide formation within the predetermined or desired range have substantially similar oxidization degrees in the air to each other.

According to example embodiments, the group of oxidation resistance elements may be selected from elements having the similar oxidative property to the elements capable of extending the supercooled liquid region (ΔTx). Namely, the group of oxidation resistance elements may be selected from elements having a Gibbs free energy of metal oxide formation of elements capable of extending the supercooled liquid region (ΔTx) within the predetermined or desired range.

For example, the group of oxidation resistance elements may be selected from elements having a Gibbs free energy of oxide formation per mole of oxygen (O₂) of about −900 kJ/mol to about −1250 kJ/mol.

Elements within the range may be selected from, for example, zirconium (Zr), beryllium (Be), magnesium (Mg), barium (Ba), manganese (Mn), lithium (Li), yttrium (Y), calcium (Ca), uranium (U), europium (Eu), strontium (Sr), lanthanum (La), cerium (Ce), neodymium (Nd), ytterbium (Yb), samarium (Sm), thorium (Th), dysprosium (Dy), lutetium (Lu), holmium (Ho), thulium (Tm), erbium (Er), and scandium (Sc), besides the above-mentioned aluminum (Al) and titanium (Ti).

The following Table 1 shows Gibbs free energy of metal oxide formation per 1 mole of oxygen (O₂) of mentioned elements.

TABLE 1

| | Δ_{f}G⁰ | | Δ_{f}G⁰ |
|---|---|---|---|
| Oxide | (kJ/mol O₂) | Oxide | (kJ/mol O₂) |
| Al₂O₃ | −1054.9 | La₂O₃ | −1137.2 |
| TiO | −990 | Ce₂O₃ | −1137.5 |
| ZrO₂ | −1042.8 | Nd₂O₃ | −1147.2 |
| BeO | −1160.2 | Yb₂O₃ | −1151.1 |
| MgO | −1138.6 | Sm₂O₃ | −1156.4 |
| BaO | −1040.6 | ThO₂ | −1169.2 |
| Mn₃O₄ | −962.4 | Dy₂O₃ | −1181 |
| Li₂O | −1122.4 | Lu₂O₃ | −1192.7 |
| Y₂O₃ | −1211.1 | Ho₂O₃ | −1194.1 |
| CaO | −1206.6 | Tm₂O₃ | −1196.3 |
| UO₂ | −1031.8 | Er₂O₃ | −1205.8 |
| Eu₂O₃ | −1037.9 | Sc₂O₃ | −1212.9 |
| SrO | −1123.8 | Ti₂O₃ | −956.1 |

By including the plurality of selected elements together, the elements may be simultaneously involved in the formation of oxide in the air to reduce (and/or prevent) the formation of crystalline oxide, so an amorphous oxide may be obtained. The amorphous oxide has almost no oxygen vacancies as mentioned above, so the oxidation resistance may be enhanced.

The metallic glass may be applied for manufacturing an article. The article may be made of a sintered product of metallic glass by, for example, introducing the metallic glass that is softened in the supercooled liquid region (ΔTx) into a mold having a predetermined or desired shape and sintering the same. The article may be applied to various fields, for example, a mobile phone case, a golf head, a watch, or the like.

The metallic glass may be applied to a conductive paste.

The conductive paste may include a conductive powder, the metallic glass, and/or an organic vehicle.

The conductive powder may be a silver (Ag)-containing metal such as silver or a silver alloy, an aluminum (Al)-containing metal such as aluminum or an aluminum alloy, a copper (Cu)-containing metal such as copper (Cu) or a copper alloy, a nickel (Ni)-containing metal such as nickel (Ni) or a nickel alloy, or a combination thereof. However, it is not limited thereto, and it may be a different kind of metal or may include an additive other than the metal.

The conductive powder may have a size of about 0.1 nm to about 50 μm, and may include one or more kinds of conductive powder.

The metallic glass is the same as described above.

The organic vehicle may include an organic compound mixed with a conductive powder and a metallic glass that imparts viscosity to the organic vehicle, and a solvent dissolving the above components.

The organic compound may include, for example, at least one selected from a (meth)acrylate-based resin, a cellulose resin such as ethyl cellulose, a phenol resin, an alcohol resin, TEFLON (tetrafluoroethylene), and a combination thereof, and may further include an additive such as a dispersing agent, a surfactant, a thickener, and a stabilizer.

The solvent may be any solvent being capable of dissolving the above compounds and may include, for example, at least one selected from terpineol, butylcarbitol, butylcarbitol acetate, pentanediol, dipentyne, limonene, ethylene glycol alkylether, diethylene glycol alkylether, ethylene glycol alkylether acetate, diethylene glycol alkylether acetate, diethylene glycol dialkylether acetate, triethylene glycol alkylether acetate, triethylene glycol alkylether, propylene glycol alkylether, propylene glycol phenylether, dipropylene glycol alkylether, tripropylene glycol alkylether, propylene glycol alkylether acetate, dipropylene glycol alkylether acetate, tripropylene glycol alkyl ether acetate, dimethylphthalic acid, diethylphthalic acid, dibutylphthalic acid, and desalted water.

The conductive powder, metallic glass, and organic vehicle may be included in amounts of about 30 wt % to about 99 wt %, about 0.1 wt % to about 20 wt %, and a balance amount, respectively, based on the total amount of the conductive paste.

The conductive paste may be fabricated by screen-printing to provide an electrode for an electronic device. The electronic device may include, for example a liquid crystal display (LCD), a plasma display device (PDP), an organic light emitting diode (OLED) display, a solar cell, and the like.

The following examples illustrate this disclosure in more detail. However, it is understood that this disclosure is not limited by these examples.

### Preparation of Metallic Glass

### Preparation Example 1

3.178 g of copper (Cu), 4.562 g of zirconium (Zr), 0.240 g of aluminum (Al), and 0.020 g of beryllium (Be) are prepared and melted using an Arc melter to provide 8 g of a Cu—Zr—Al—Be mother alloy. The Cu—Zr—Al—Be mother alloy is introduced into a quartz tube and mounted to a melt spinner. The melt spinner is maintained in vacuum, and then argon (Ar) gas is supplied into the chamber to provide an argon atmosphere. The metal is fused using an induction heater, and argon (Ar) gas is flowed into the quartz tube to discharge the fused metal through the outlet of the quartz tube. The fused metal is rapidly cooled in a Cu sheet to provide a metallic glass Cu₄₅Zr₄₅Al₈Be₂ ribbon. The metallic glass Cu₄₅Zr₄₅Al₈Be₂ ribbon is cut to a size of about 5 mm×5 mm to provide a Cu₄₅Zr₄₅Al₈Be₂ specimen.

### Comparative Preparation Example 1

A Cu₅₀Zr₅₀ specimen is prepared in accordance with the same procedure as in Preparation Example 1, except that 3.285 g of copper (Cu) and 4.715 g of zirconium (Zr) are used instead of 3.178 g of copper (Cu), 4.562 g of zirconium (Zr), 0.240 g of aluminum (Al), and 0.020 g of beryllium (Be).

### Comparative Preparation Example 2

A Cu₄₆Zr₄₆Al₈ specimen is prepared in accordance with the same procedure as in Preparation Example 1, except that 3.188 g of copper (Cu), 4.577 g of zirconium (Zr), and 0.235 g of aluminum (Al) are used instead of 3.178 g of copper (Cu), 4.562 g of zirconium (Zr), 0.240 g of aluminum (Al), and 0.020 g of beryllium (Be).

### Comparative Preparation Example 3

A Cu₄₅Zr₄₅Al₈Si₂ specimen is prepared in accordance with the same procedure as in Preparation Example 1, except that 3.161 g of copper (Cu), 4.538 g of zirconium (Zr), 0.239 g of aluminum (Al), and 0.062 g of silicon (Si) are used instead of 3.178 g of copper (Cu), 4.562 g of zirconium (Zr), 0.240 g of aluminum (Al), and 0.020 g of beryllium (Be).

(Silicon (Si) has a Gibbs free energy of metal oxide formation) (Δ_{f}G° per mole of oxygen (O₂) of −856.3 kJ/mol O₂)

### Comparative Preparation Example 4

A Cu₄₅Zr₄₅Al₈Sn₂ specimen is prepared in accordance with the same procedure as in Preparation Example 1, except that 3.084 g of copper (Cu), 4.427 g of zirconium (Zr), 0.233 g of aluminum (Al), and 0.256 g of tin (Sn) are used instead of 3.178 g of copper (Cu), 4.562 g of zirconium (Zr), 0.240 g of aluminum (Al), and 0.020 g of beryllium (Be).

(Tin (Sn) has a Gibbs free energy of metal oxide formation) (Δ_{f}G° per 1 mole of oxygen (O₂) of −503.8 kJ/mol O₂)

Evaluation 1: Supercooled Temperature Region

The metallic glass specimens according to Preparation Example 1 and Comparative Preparation Examples 1 to 4 are measured for glass transition temperature (Tg), crystalline temperature (Tx), and a supercooled temperature region (ΔTx).

The glass transition temperature (Tg), the crystalline temperature (Tx), and the supercooled temperature region (ΔTx) are measured using differential scanning calorimetry (DSC), and the metallic glass specimens according to Preparation Example 1 and Comparative Preparation Examples 1 to 4 are input into a differential scanning calorimeter and heated at a speed of 40 K/min. The point of starting endothermic refers to the glass transition temperature (Tg), and the point starting exothermic refers to the crystalline temperature (Tx).

The results are shown in Table 2.

TABLE 2

| | metallic glass | Tg (K) | Tx (K) | ΔTx (K) |
|---|---|---|---|---|
| Preparation | Cu₄₅Zr₄₅Al₈Be₂ | 723 | 794 | 71 |
| Example 1 | | | | |
| Comparative | Cu₅₀Zr₅₀ | 697 | 738 | 41 |
| Preparation | | | | |
| Example 1 | | | | |
| Comparative | Cu₄₆Zr₄₆Al₈ | 728 | 791 | 63 |
| Preparation | | | | |
| Example 2 | | | | |
| Comparative | Cu₄₅Zr₄₅Al₈Si₂ | 742 | 816 | 74 |
| Preparation | | | | |
| Example 3 | | | | |
| Comparative | Cu₄₅Zr₄₅Al₈Sn₂ | 745 | 784 | 39 |
| Preparation | | | | |
| Example 4 | | | | |

Referring to Table 2, it is confirmed that the metallic glass according to Preparation Example 1 extends the supercooled liquid region more than the metallic glass according to Comparative Preparation Examples 1, 2, and 4. In addition, the metallic glass according to Preparation Example 1 has a similar supercooled liquid region to the metallic glass according to Comparative Preparation Example 3.

Evaluation 2: Confirmation of Amorphous Oxide

The metallic glass specimens according to Preparation Example 1 and Comparative Preparation Examples 1 and 2 are heated to the temperature of the supercooled liquid region (ΔTx), and then the status of the oxide at a surface of the metallic glass is observed. An epoxy layer and Pt are coated on the metallic glass to prevent the oxide from be contaminated.

The oxide is observed with a transmission electron microscope (TEM).

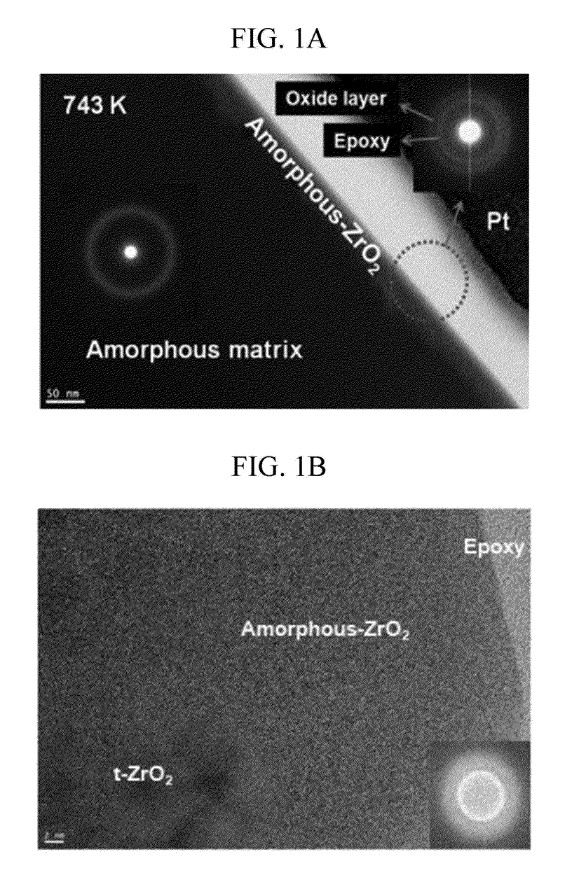

FIG. 1A is a transmission electron microscope (TEM) photograph showing the oxide layer of a metallic glass specimen according to Preparation Example 1, and FIG. 1B is a transmission electron microscope (TEM) photograph showing an enlarged portion of the oxide layer shown in FIG. 1A.

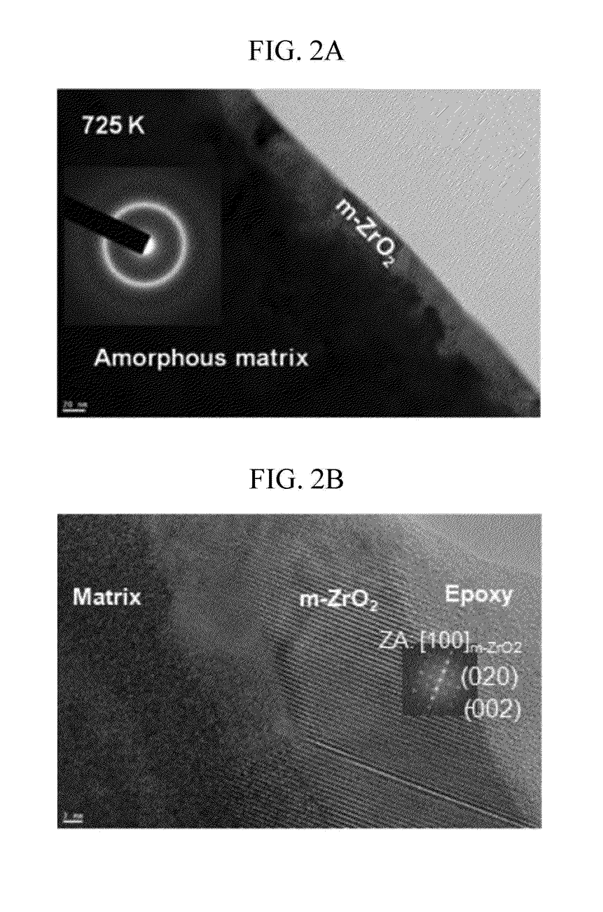

FIG. 2A is a transmission electron microscope (TEM) photograph showing the oxide layer of a metallic glass specimen according to Comparative Preparation Example 1, and FIG. 2B is a transmission electron microscope (TEM) photograph showing an enlarged portion of the oxide layer shown in FIG. 2A.

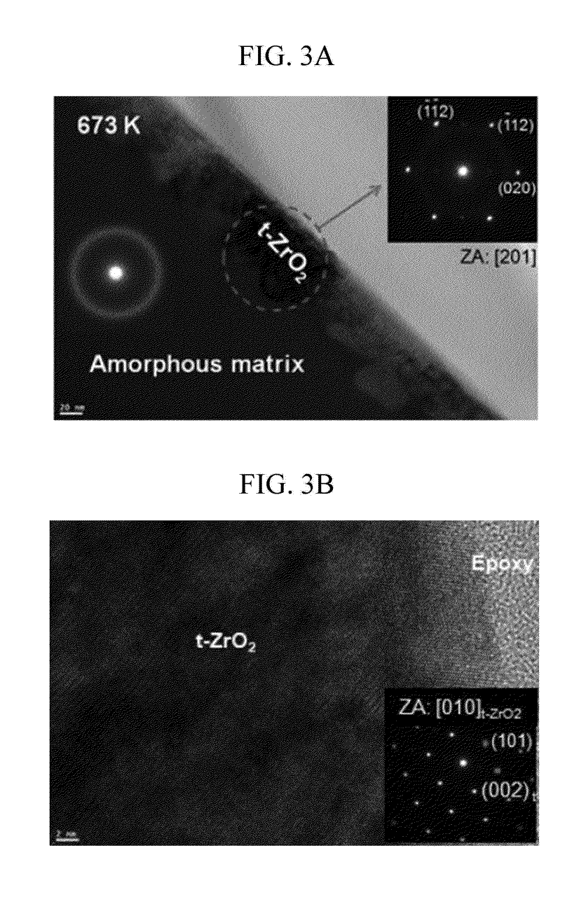

FIG. 3A is a transmission electron microscope (TEM) photograph showing the oxide layer of a metallic glass specimen according to Comparative Preparation Example 2, and FIG. 3B is a transmission electron microscope (TEM) photograph showing an enlarged portion of the oxide layer shown in FIG. 3A.

Referring to FIG. 1A and FIG. 1B, it is confirmed that the amorphous oxide (amorphous-ZrO₂) is formed at the surface when the metallic glass specimen according to Preparation Example 1 is heated at 743 K.

On the other hand, referring to FIG. 2A and FIG. 2B, it is confirmed that monoclinic oxide (m-ZrO₂) is formed at the surface of the metallic glass specimen according to Comparative Preparation Example 1 at 725 K. In addition, referring to FIG. 3A and FIG. 3B, it is confirmed that the metallic glass according to Comparative Preparation Example 2 is already crystallized at a temperature of 673 K, which is lower than the glass transition temperature (Tg) of 728 K, to provide a tetragonal oxide (t-ZrO2).

Evaluation 3: Oxidation Resistance of Metallic Glass

Each metallic glass specimen according to Preparation Example 1 and Comparative Preparation Examples 1 to 4 undergoes thermogravimetric analysis and is heated to 800° C. at a speed of about 10° C./min to monitor weight change depending upon temperature.

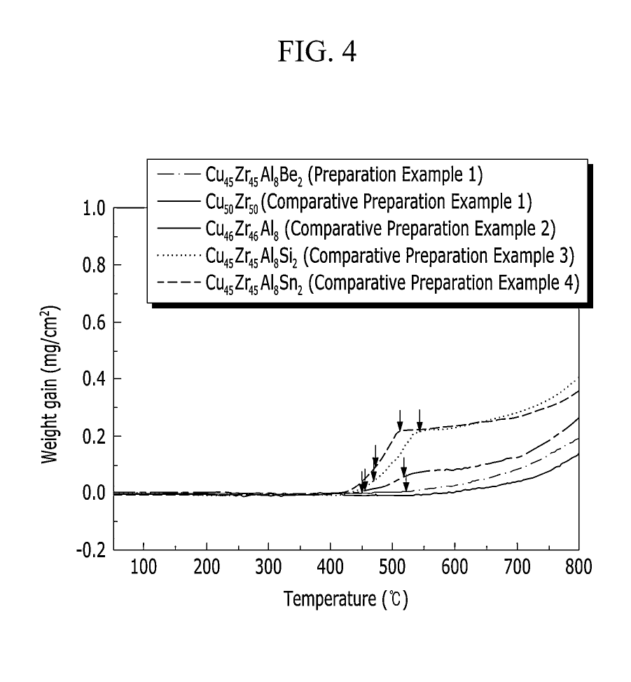

The results are shown in FIG. 4.

FIG. 4 is a graph showing weight change of metallic glass specimens according to Preparation Example 1 and Comparative Preparation Examples 1 to 4 depending upon temperature.

Referring to FIG. 4, it is understood that the weight change comes from the weight increase caused by forming an oxide due to the oxidation of the metallic glass specimen.

FIG. 4 shows that the metallic glass specimen according to Preparation Example 1 begins to be oxidized from about 500° C. and increases in weight by less than or equal to about 0.2 mg/cm² up to 800° C.

On the other hand, the metallic glass specimens according to Comparative Preparation Examples 2 to 4 are more oxidized than the metallic glass specimen according to Preparation Example 1, and particularly, the metallic glass specimens according to Comparative Preparation Examples 3 and 4 are rapidly oxidized from about 450° C. and shows weight increase of about 0.3 to 0.4 mg/cm² up to 800° C.

From overall results of Evaluation 1 and Evaluation 2, it is confirmed that the metallic glass specimen according to Preparation Example 1 improves the oxidation resistance compared to the metallic glass specimens according to Comparative Preparation Examples 1 to 4 while extending the supercooled liquid region.

While some example embodiments have been particularly shown and described, it will be understood by one of ordinary skill in the art that variations in form and detail may be made therein without departing from the spirit and scope of the claims.

What is claimed is:

1. A metallic glass comprising:
an amorphous alloy part including a plurality of elements; and
an amorphous oxide in a supercooled liquid region.

2. The metallic glass of claim 1, wherein
the amorphous oxide is on the amorphous alloy part of the metallic glass.

3. The metallic glass of claim 1, wherein the metallic glass includes at least three kinds of elements having a Gibbs free energy of oxide formation per mole of oxygen (O₂) of about −900 to about −1250 kJ/mol.

4. The metallic glass of claim 3, wherein the at least three kinds of elements in the metallic glass are selected from aluminum (Al), titanium (Ti), zirconium (Zr), beryllium (Be), magnesium (Mg), barium (Ba), manganese (Mn), lithium (Li), yttrium (Y), calcium (Ca), uranium (U), europium (Eu), strontium (Sr), lanthanum (La), cerium (Ce), neodymium (Nd), ytterbium (Yb), samarium (Sm), thorium (Th), dysprosium (Dy), lutetium (Lu), holmium (Ho), thulium (Tm), erbium (Er), and scandium (Sc).

5. The metallic glass of claim 4, wherein the at least three kinds of elements in the metallic glass include: zirconium (Zr), aluminum (Al), and beryllium (Be).

6. The metallic glass of claim 4, wherein the metallic glass further includes:
a low resistance element, wherein
the low resistance element has a resistivity of less than about 15 μΩcm, and
the at least three kinds of elements are different than the low resistance element.

7. The metallic glass of claim 6, wherein the low resistance element includes at least one of copper (Cu), aluminum (Al), silver (Ag), and gold (Au).

8. The metallic glass of claim 7, wherein the metallic glass includes copper (Cu), zirconium (Zr), aluminum (Al), and beryllium (Be).

9. The metallic glass of claim 8, wherein the amorphous oxide includes amorphous zirconium oxide (ZrO₂).

10. An article comprising:
a sintered product of the metallic glass according to claim 1.

11. The article of claim 10, wherein
the amorphous oxide is on the amorphous alloy part of the metallic glass.

12. The article of claim 10, wherein the metallic glass includes at least three kinds of elements having a Gibbs free energy of oxide formation per mole of oxygen (O₂) of about −900 to about −1250 kJ/mol.

13. The article of claim 10, wherein the metallic glass includes copper (Cu), zirconium (Zr), aluminum (Al), and beryllium (Be).

14. The article of claim 13, wherein the amorphous oxide includes amorphous zirconium oxide (ZrO₂).

15. A conductive paste comprising:
a conductive powder,
the metallic glass of claim 1, and
an organic vehicle.

16. The conductive paste of claim 15, wherein the conductive powder includes one of aluminum (Al), silver (Ag), copper (Cu), nickel (Ni), an alloy thereof, and a combination thereof.

17. The conductive paste of claim 15, wherein
the amorphous oxide is on the amorphous alloy part of the metallic glass.

18. The conductive paste of claim 15, wherein the metallic glass includes at least three kinds of elements having a Gibbs free energy of oxide formation per mole of oxygen (O₂) of about −900 to about −1250 kJ/mol.

19. The conductive paste of claim 18, wherein the at least three kinds of elements in the metallic glass are selected from aluminum (Al), titanium (Ti), zirconium (Zr), beryllium (Be), magnesium (Mg), barium (Ba), manganese (Mn), lithium (Li), yttrium (Y), calcium (Ca), uranium (U), europium (Eu), strontium (Sr), lanthanum (La), cerium (Ce), neodymium (Nd), ytterbium (Yb), samarium (Sm), thorium (Th), dysprosium (Dy), lutetium (Lu), holmium (Ho), thulium (Tm), erbium (Er), and scandium (Sc).

20. The conductive paste of claim 19, wherein the at least three kinds of elements in the metallic glass include zirconium (Zr), aluminum (Al), and beryllium (Be).

21. The conductive paste of claim 19, wherein the metallic glass further includes a low resistance element having resistivity of less than about 15 μΩcm.

22. The conductive paste of claim 21, wherein the low resistance element in the metallic glass includes at least one of copper (Cu), aluminum (Al), silver (Ag), and gold (Au).

23. The conductive paste of claim 22, wherein the metallic glass includes copper (Cu), zirconium (Zr), aluminum (Al), and beryllium (Be).

24. The conductive paste of claim 23, wherein the amorphous oxide includes amorphous zirconium oxide (ZrO₂).

25. The conductive paste of claim 15, wherein the conductive powder, the metallic glass and amorphous oxide, and the organic vehicle are included in amounts of about 30 wt % to about 99 wt %, about 0.1 wt % to about 20 wt %, and a balance amount, based on the total amount of the conductive paste, respectively.

26. An electronic device comprising:
an electrode including a sintered product of the conductive paste according to claim 15.
